(19) United States
(12) Patent Application Publication
(10) Pub. No.: US 2026/0179051 A1
(43) Pub. Date: Jun. 25, 2026

(54) COMMUNICATION MEASURING METHOD, PROGRAM, AND COMMUNICATION MEASURING SYSTEM

(71) Applicant: Panasonic Intellectual Property Management Co., Ltd., Osaka (JP)

(72) Inventors: Takuma SHIRAI, Osaka (JP); Kenichi IRIE, Osaka (JP); Yosuke IZAWA, Osaka (JP); Jakusei KIYOSAKI, Hyogo (JP)

(73) Assignee: Panasonic Intellectual Property Management Co., Ltd., Osaka (JP)

(21) Appl. No.: 19/128,998

(22) PCT Filed: Nov. 9, 2023
(86) PCT No.: PCT/JP2023/040444

§ 371 Date: May 10, 2025

(30) Foreign Application Priority Data
Nov. 15, 2022 (JP) 2022-182898

(51) Int. Cl. G06Q 10/1091; G10L 25/51; G10L 25/78

(52) U.S. Cl. CPC G06Q 10/1091; G10L 25/51; G10L 25/78

(57) ABSTRACT

A communication measuring method includes selecting a first worker and a second worker by reference to relationship information about a relationship between one worker and another worker, determining, by reference to a first piece of location information, a second piece of location information, a first piece of voice information, and a second piece of voice information, whether or not the first worker and the second worker are having a conversation, and calculating, based on a decision made in the conversation determination step, at least one of a numerical number of times, or a duration, of conversations that the first worker and the second worker have had.

### TECHNICAL FIELD

The present disclosure generally relates to a communication measuring method, a program, and a communication measuring system. More particularly, the present disclosure relates to a communication measuring method, a program, and a communication measuring system, all of which are used to monitor communication between workers.

### BACKGROUND ART

Patent Literature 1 discloses a communication evaluation system. The communication evaluation system of Patent Literature 1 measures, based on data about the location information of a mobile device carried by a person belonging to an organization, the distance between two persons belonging to the organization. The communication evaluation system of Patent Literature 1 determines, when finding that the distance measured continues to fall within a predetermined distance range for a predetermined amount of time, that a communication be established between the two persons.

The communication evaluation system of Patent Literature 1 determines, based on the two factors, namely, the distance between two target persons and the time, whether a communication (conversation) is established between the two persons or not. Thus, in some cases, the two target persons may just be in close proximity to each other, not communicating with each other.

### CITATION LIST

### Patent Literature

Patent Literature 1: WO 2019/155629 A1

### SUMMARY OF INVENTION

In view of the foregoing background, it is therefore an object of the present disclosure to provide a communication measuring method, a program, and a communication measuring system, all of which may contribute to measuring the conversation between workers more accurately.

A communication measuring method according to an aspect of the present disclosure is performed by a computer system. The communication measuring method includes a selection step, a conversation determination step, and a calculation step. The selection step includes selecting a first worker and a second worker by reference to relationship information about a relationship between one worker and another worker. The conversation determination step includes determining, by reference to a first piece of location information, a second piece of location information, a first piece of voice information, and a second piece of voice information, whether or not the first worker and the second worker are having a conversation. The first piece of location information is a piece of information indicating a location of the first worker. The second piece of location information is a piece of information indicating a location of the second worker. The first piece of voice information is a piece of information indicating a state of a voice around the first worker. The second piece of voice information is a piece of information indicating a state of a voice around the second worker. The calculation step includes calculating, based on a decision made in the conversation determination step, at least one of a numerical number of times, or a duration, of conversations that the first worker and the second worker have had.

A program according to another aspect of the present disclosure is designed to cause one or more processors to perform the communication measuring method described above.

A communication measuring system according to still another aspect of the present disclosure includes a selector, a conversation determiner, and a calculator. The selector selects a first worker and a second worker by reference to relationship information about a relationship between one worker and another worker. The conversation determiner determines, by reference to a first piece of location information, a second piece of location information, a first piece of voice information, and a second piece of voice information, whether or not the first worker and the second worker are having a conversation. The first piece of location information is a piece of information indicating a location of the first worker. The second piece of location information is a piece of information indicating a location of the second worker. The first piece of voice information is a piece of information indicating a state of a voice around the first worker. The second piece of voice information is a piece of information indicating a state of a voice around the second worker. The calculator calculates, based on a decision made by the conversation determiner, at least one of a numerical number of times, or a duration, of conversations that the first worker and the second worker have had.

### BRIEF DESCRIPTION OF DRAWINGS

FIG. 1 is a schematic representation illustrating a configuration for a communication measuring system according to an exemplary embodiment;

FIG. 2 is a conceptual diagram illustrating the concept of conversation determination processing to be performed by the communication measuring system; and

FIG. 3 is a flowchart showing the procedure in which the communication measuring system works.

### DESCRIPTION OF EMBODIMENTS

Preferred embodiments of the present disclosure will now be described in detail with reference to the accompanying drawings. In the following description, any pair of constituent elements, having the same function and shown in multiple drawings, will be designated by the same reference numeral and description thereof will be omitted herein. Note that the embodiments to be described below are only exemplary ones of various embodiments of the present disclosure and should not be construed as limiting. Rather, the exemplary embodiments (including their variations) may be readily modified in various manners depending on a design choice or any other factor without departing from the scope of the present disclosure. Note that the embodiments (including their variations) to be described below may be adopted in combination as appropriate.

### Embodiment

### (1) Overview

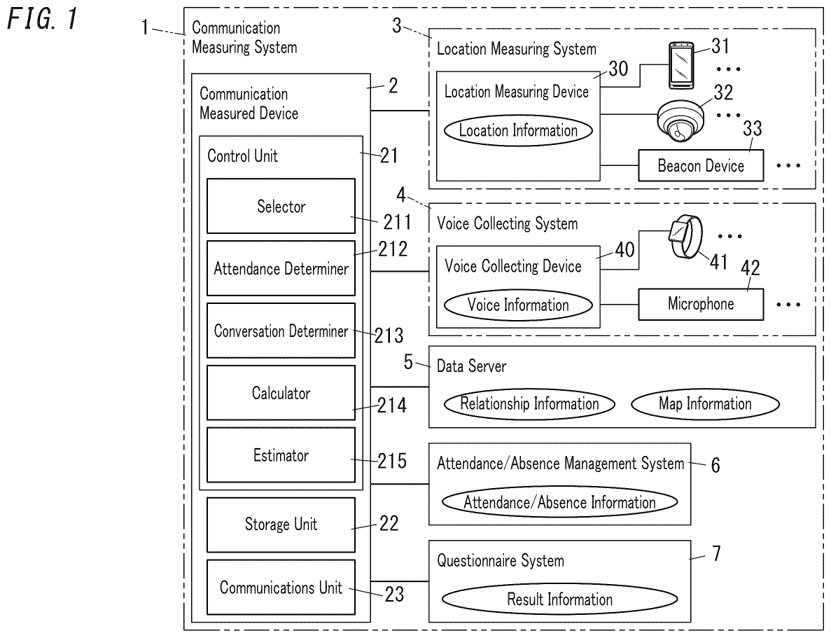

First, an overview of a communication measuring method, a program, and a communication measuring system 1 according to this embodiment will be described with reference to FIG. 1. The communication measuring system 1 according to this embodiment is used to estimate a worker's engagement.

As used herein, the “engagement” may encompass “work engagement” and “employee engagement.” The engagement may be, for example, defined by the following two concepts:
(1) commitment to an organization, including, specifically, an emotional commitment (i.e., emotional affection to the organization) and a continuing commitment (i.e., wish to stay in the organization); and
(2) extra-assignment activity (arbitrary activity conducted to allow the organization to function effectively).

As used herein, the “worker” may refer to any person who works in general. Note that the “worker” as used herein refers to not only a person who earns a wage as a compensation for his or her labor but also a person who works for no compensation. In the following description of embodiments, a situation where the engagement of a person who earns a wage as a compensation for his or her labor is estimated will be described as a typical example. Thus, the communication measuring system 1 is used at, for example, a business enterprise, a local government office, or an association. In the following description, a situation where the communication measuring system 1 is used at a business enterprise will be described as a typical example. That is to say, the workplace for the worker according to this embodiment is an office.

As shown in FIG. 1, a communication measuring system 1 according to this embodiment includes a selector 211, a conversation determiner 213, and a calculator 214.

The selector 211 selects a first worker and a second worker by reference to relationship information about a relationship between one worker and another worker.

The conversation determiner 213 determines, by reference to a first piece of location information, a second piece of location information, a first piece of voice information, and a second piece of voice information, whether or not the first worker and the second worker are having a conversation. The first piece of location information is a piece of information indicating the location of the first worker. The second piece of location information is a piece of information indicating the location of the second worker. The first piece of voice information is a piece of information indicating the state of a voice around the first worker. The second piece of voice information is a piece of information indicating the state of a voice around the second worker.

As used herein, the “state of a voice around a worker” includes “the absence of any voice uttered around the worker” and “the presence of any voice uttered around the worker.” Also, the “presence of any voice around the worker” may refer to both a situation where another worker is uttering a voice around one worker and a situation where the latter worker is uttering a voice by him-or herself. That is to say, the presence of any voice around the first worker may include both a situation where the first worker is uttering a voice by him-or herself and a situation where a second worker is uttering a voice beside the first worker.

The calculator 214 calculates, based on a decision made by the conversation determiner 213, at least one of the number of times, or the duration, of conversations that the first worker and the second worker have had.

The communication measuring system 1 according to this embodiment determines, by reference to pieces of location information of workers and voice information about any voice around the workers, whether workers are having a conversation between them or not, and then calculates at least one of the number of times, or the duration, of conversations that the workers have had between them. Thus, the communication measuring system 1 according to this embodiment contributes to measuring a conversation between workers more accurately than, for example, a system for determining, by reference to location information and time, whether workers are having a conversation between them.

The functions of the communication measuring system 1 may also be implemented as a communication measuring method. A communication measuring method according to this embodiment is performed by a computer system (communication measuring system 1). The communication measuring method includes a selection step, a conversation determination step, and a calculation step. The selection step includes selecting a first worker and a second worker by reference to relationship information about a relationship between one worker and another worker. The conversation determination step includes determining, by reference to a first piece of location information, a second piece of location information, a first piece of voice information, and a second piece of voice information, whether or not the first worker and the second worker are having a conversation. The calculation step includes calculating, based on a decision made in the conversation determination step, at least one of a numerical number of times, or a duration, of conversations that the first worker and the second worker have had.

Optionally, the communication measuring method may also be implemented as a program. A program according to this embodiment is designed to cause one or more processors of a computer system to perform the communication measuring method described above. The program may be stored in a non-transitory storage medium which is readable for the computer system.

### (2) Details

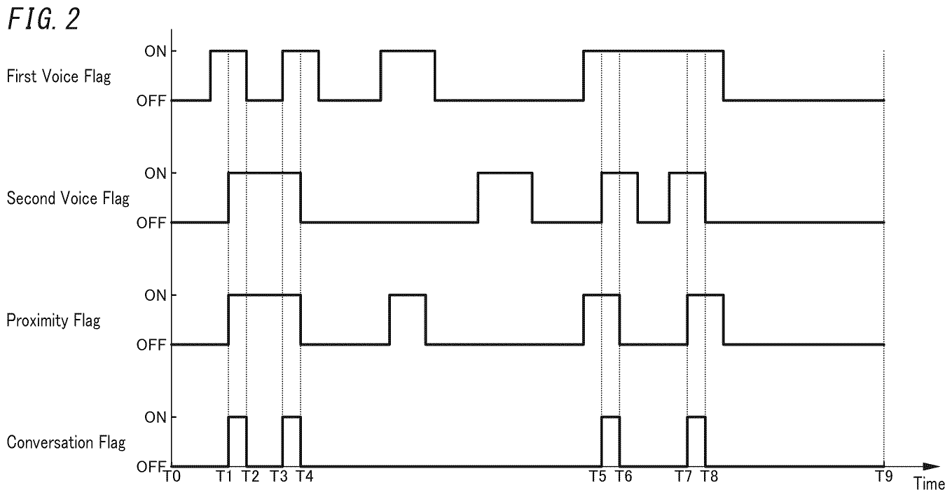

A more specific configuration for the communication measuring system 1 according to this embodiment will be described with reference to FIGS. 1 and 2.

### (2.1) Communication Measuring System

In this embodiment, there are a plurality of workers. The communication measuring system 1 estimates the respective engagements of the plurality of workers every predetermined estimation period. More specifically, the communication measuring system 1 calculates at least one of the number of times, or the duration, of conversations that the workers have had between them and then estimates the respective engagements of the individual workers. Note that the predetermined estimation period may be, for example, one week.

As shown in FIG. 1, the communication measuring system 1 includes a communication measuring device 2, a location measuring system 3, a voice collecting system 4, a data server 5, an attendance/absence management system 6, and a questionnaire system 7.

### (2.2) Location Measuring System

The location measuring system 3 collects, by measuring, respective pieces of location information of a plurality of workers. The location information may include, for example, information about the respective coordinates of the plurality of workers. The “coordinates” may be, for example, coordinates at an office (workplace).

As shown in FIG. 1, the location measuring system 3 includes a location measuring device 30, a plurality of mobile devices 31, a plurality of image capturing units 32, and a plurality of beacon devices 33. In the following description, each of the plurality of mobile devices 31 will be hereinafter simply referred to as a “mobile device 31.” Each of the plurality of image capturing units 32 will be hereinafter simply referred to as an “image capturing unit 32.” Each of the plurality of beacon devices 33 will be hereinafter simply referred to as a “beacon device 33.” The plurality of beacon devices 33 may be installed, for example, on the ceiling, walls, or floor of a workplace. The beacon device 33 transmits a beacon signal. That is to say, the beacon device 33 according to this embodiment serves as a beacon transmitter.

The mobile device 31 is a terminal device carried by each of the plurality of workers. Examples of the mobile devices 31 include smartphones, laptop computers (personal computers), wearable devices, and dedicated beacon receivers. In this embodiment, the mobile device 31 is a smartphone. The mobile device 31 receives a beacon signal and measures the received signal strength indicator of the beacon signal. The mobile device 31 transmits information about the received signal strength indicator and identification information of the mobile device 31 to the location measuring device 30. The identification information of the mobile device 31 is associated with information about the worker who carries the mobile device 31 with him or her.

The plurality of image capturing units 32 may be installed, for example, on the ceiling or walls of the workplace. The image capturing unit 32 generates a captured image, of which the image capturing range is defined to be a range surrounding the image capturing unit 32. The image capturing unit 32 identifies who the worker shot within the image capturing range is among the plurality of workers. The image capturing unit 32 may carry out, for example, face detection processing for detecting a human face part of the captured image, thereby extracting a facial image which is an image representing a human face part. When a facial image is extracted from the captured image, the image capturing unit 32 collates the facial image thus extracted with the facial images (template data) of a plurality of workers registered in advance with the data server 5, for example (i.e., performs matching processing), thereby identifying the worker shot within the image capturing range.

After having identified the worker shot within the image capturing range, the image capturing unit 32 transmits identification information about the worker thus identified and information indicating its own identifier to the location measuring device 30. Optionally, the information indicating the identifier may include location information indicating the location of the image capturing unit 32.

The location measuring device 30 may be a server, for example. The location measuring device 30 includes, as a principal constituent element, a computer system including one or more processors and one or more memories. The functions of the location measuring device 30 are performed by making the one or more processors execute a program stored in the memory. The program may be stored in advance in the memory. Alternatively, the program may also be downloaded via a telecommunications line such as the Internet or distributed after having been stored in a non-transitory storage medium such as a memory card.

The location measuring device 30 calculates, by reference to the information about the received signal strength indicator provided by the mobile device 31, respective distances between the mobile device 31 and the plurality of beacon devices 33. In addition, the location measuring device 30 also measures, based on the respective distances between the mobile device 31 and the plurality of beacon devices 33 and respective pieces of location information of the plurality of beacon devices 33, the location information of the mobile device 31 by triangulation method. The location measuring device 30 transmits the location information of the mobile device 31 as the location information of the worker who carries the mobile device 31 with him or her (i.e., the worker's location information corresponding to the identification information of the mobile device 31) to the communication measuring device 2.

In addition, the location measuring device 30 also transmits, by reference to the identification information provided by the image capturing unit 32 and the information indicating the identifier of the image capturing unit 32, the location information of the image capturing unit 32, for example, as the location information of the worker shot within the image capturing range of the image capturing unit 32 to the communication measuring device 2.

Note that the location measuring device 30 may transmit at least one of the location information of the mobile device 31 carried by the worker with him or her or the location information acquired by having the worker shot by the image capturing unit 32 to the communication measuring device 2.

As can be seen from the foregoing description, the first piece of location information and the second piece of location information according to this embodiment are either respective pieces of location information of the mobile devices 31 carried by the first worker and the second worker with them or respective pieces of location information acquired by having the first worker and the second worker shot by the image capturing unit 32 installed in the workplace. Measuring the worker's location accurately by reference to either the location information of the mobile device 31 carried by the worker with him or her or the location information acquired by having the worker shot by the image capturing unit 32 installed in the workplace allows for measuring the conversation between the workers more accurately.

### (2.3) Voice Collecting System

The voice collecting system 4 collects voice information representing the state of a voice around each of the plurality of workers.

As shown in FIG. 1, the voice collecting system 4 includes a voice collecting device 40, a plurality of mobile devices 41, and a plurality of microphones 42. In the following description, each of the plurality of mobile devices 41 will be hereinafter simply referred to as a “mobile device 41.” Each of the plurality of microphones 42 will be hereinafter simply referred to as a “microphone 42.”

Examples of the mobile device 41 include smartphones, laptop computers (personal computers), wearable devices, and voice recorders. In this embodiment, the mobile device 41 is a wearable device to be carried by the worker with him or her by wearing the mobile device 41 on his or her wrist. The mobile device 41 has a microphone to pick up voice information representing the state of a voice around the worker. The mobile device 41 transmits the voice information thus picked up to the voice collecting device 40.

Optionally, the mobile device 41 may have the capability of measuring biometric information of the worker. That is to say, the mobile device 41 may serve as a biometric information measuring device. The biometric information includes at least one selected from the group consisting of heart rate, blood pressure, skin temperature, the amount of perspiration, and voice information.

The plurality of microphones 42 may be installed, for example, on the ceiling, walls, floor of the workplace. The microphone 42 picks up voice information representing the state of a voice around its own device. The microphone 42 transmits the voice information thus picked up and the information representing its own identifier to the voice collecting device 40.

The voice collecting device 40 may be a server, for example. The voice collecting device 40 includes, as a principal constituent element, a computer system including one or more processors and one or more memories. The functions of the voice collecting device 40 are performed by making the one or more processors execute a program stored in the memory. The program may be stored in advance in the memory. Alternatively, the program may also be downloaded via a telecommunications line such as the Internet or distributed after having been stored in a non-transitory storage medium such as a memory card.

The voice collecting device 40 transmits the voice information provided by the mobile device 41 as voice information representing the state of a voice around the worker who carries the mobile device 41 with him or her to the communication measuring device 2.

Also, the voice collecting device 40 according to this embodiment makes voice print analysis of the voice information picked up by the microphone 42, thereby identifying who has the voice, included in the voice information picked up by the microphone 42, among the plurality of workers. The voice collecting device 40 collates the voice included in the voice information picked up by the microphone 42 with the voice print information of the plurality of workers preregistered with the data server 5, for example, thereby identifying the worker who has uttered the voice included in the voice information picked up by the microphone 42.

After having identified the worker who has uttered the voice included in the voice information picked up by the microphone 42, the voice collecting device 40 transmits the voice information picked up by the microphone 42 as voice information representing the state of the voice around the worker thus identified to the communication measuring device 2. More specifically, after having identified the worker, the voice collecting device 40 transmits the voice information picked up by the microphone 42 as voice information representing the state of the voice uttered around the worker thus identified to the communication measuring device 2.

Note that the voice collecting device 40 may transmit at least one of the voice information acquired by the mobile device 41 or the voice information picked up by the microphone 42 installed in the workplace to the communication measuring device 2.

As can be seen from the foregoing description, the first piece of voice information and the second piece of voice information according to this embodiment are either respective pieces of voice information acquired by the mobile devices 41 carried by the first worker and the second worker with them or respective pieces of voice information picked up by the microphone 42 installed in the workplace. Using either the voice information acquired by the mobile devices 41 carried by the workers with them or respective pieces of voice information picked up by the microphone 42 installed in the workplace allows for reducing the chances of determining, by mistake, that the workers be having a conversation in a situation where the workers are just in close proximity to each other. Thus, the communication measuring system 1 according to this embodiment may contribute to measuring the conversation between the workers even more accurately.

### (2.4) Data Server

The data server 5 stores relationship information. As used herein, the “relationship information” is a piece of information about the relationship between a plurality of workers at their workplace (such as a business enterprise, a local government office, or an association). More specifically, the relationship information may include, for example, information about the hierarchy between the plurality of workers. The information about the hierarchy between the plurality of workers may be, for example, information about the respective positions of the plurality of workers. As used herein, the “position” refers to his or her position at work. The position may be represented as either a title or a rank. That is to say, the relationship information includes information about the respective positions of one worker and another worker, who is different from the former worker, to indicate which worker is higher in rank than the other worker. The relationship information associates information about Worker A with, for example, information about Worker B who is a primary boss of (i.e. an immediate superior) of Worker A, information about Worker C who is a secondary boss of (i.e. an immediate superior of the immediate superior) of Worker A, information about Worker D who is a coworker of (i.e., at the same position as) Worker A, and information about Worker E who is a subordinate of Worker A.

In addition, the relationship information may include, for example, organization information about the organization (such as a department or section) to which each of the plurality of workers belongs. The departments or sections are distinguished by, for example, names such as an “XXX department,” a “YYY division,” or a “ZZZ center.” In addition, the relationship information further includes business assignment information about the business assignment (such as a project) in which each of the plurality of workers is engaged.

Besides, the data server 5 further stores map information of the workplace. The map information is a piece of information including layout information of a facility for use as the workplace. Optionally, the map information may also be three-dimensional model data such as the building information modeling (BIM) data of the facility.

The data server 5 according to this embodiment transmits the relationship information and the map information to the communication measuring device 2.

### (2.5) Attendance/Absence Management System

The attendance/absence management system 6 generates attendance/absence information of each of the plurality of workers. As used herein, the “attendance/absence information” refers to a piece of information indicating whether a plurality of workers, including the first worker and the second worker, are present at, or absent from, work. For example, each of the plurality of workers passes his or her mobile device 41 over a reader of the attendance/absence management system 6 when arriving at, and leaving, the office. Then, the attendance/absence management system 6 reads out the identification information of the mobile device 41 from the mobile device 41, thereby generating the attendance/absence information for each of the plurality of workers. The attendance/absence information includes information about the time of arrival at the workplace and information about the time of leaving the workplace. Alternatively, an integrated circuit (IC) card or the mobile device 31 may also be passed over the reader of the attendance/absence management system 6. The attendance/absence management system 6 according to this embodiment transmits the attendance/absence information to the communication measuring device 2.

### (2.6) Questionnaire System

The questionnaire system 7 distributes a questionnaire to a plurality of workers and stores result information of the questionnaire collected.

The questionnaire distributed by the questionnaire system 7 may include, for example, a questionnaire about attendance/absence, a daily report, and a questionnaire for use to estimate engagement. The result information of the questionnaire includes information about the respective dates of attendance of each of a plurality of workers including at least the first worker and the second worker.

The questionnaire system 7 according to this embodiment transmits the result information to the communication measuring device 2.

### (2.7) Communication Measuring Device

As shown in FIG. 1, the communication measuring device 2 includes a control unit 21, a storage unit 22, and a communications unit 23.

The storage unit 22 is a storage device implemented as either a hard disk drive (HDD) or a solid-state drive (SSD), for example. The storage unit 22 stores information. The storage unit 22 stores, for example, the location information acquired from the location measuring system 3, the voice information acquired from the voice collecting system 4, the relationship information acquired from the data server 5, the attendance/absence information acquired from the attendance/absence management system 6, and the result information acquired from the questionnaire system 7.

The communications unit 23 includes a communications interface device. The communications unit 23 is ready to communicate with an external device (such as the location measuring system 3, the voice collecting system 4, the data server 5, the attendance/absence management system 6, and the questionnaire system 7) via the communications interface device. As used herein, the phrase “to be ready to communicate” means being able to transmit and receive signals either directly or indirectly via a network or a repeater, for example, by an appropriate wired or wireless communication method.

The control unit 21 includes a computer system including one or more processors and a memory. The functions of the control unit 21 are performed by making the processor of the computer system execute a program stored in the memory of the computer system. The program may be stored in advance in the memory. Alternatively, the program may also be downloaded via a telecommunications line such as the Internet or distributed after having been stored in a non-transitory storage medium such as a memory card.

The control unit 21 includes a selector 211, an attendance determiner 212, a conversation determiner 213, a calculator 214, and an estimator 215.

The selector 211 performs selecting processing (hereinafter also referred to as a “selection step”) including selecting a first worker and a second worker by reference to the relationship information about the relationship between one worker and another worker.

The selector 211 according to this embodiment selects, as the first worker, a worker as a target of engagement estimation. In addition, the selector 211 also selects, as the second workers, a boss of the first worker, a subordinate of the first worker, and a coworker belonging to the same department as the first worker by reference to the relationship information. In other words, the selector 211 selects, as the second worker, at least one worker having a predetermined relationship with the first worker by reference to the relationship information.

The communication measuring system 1 according to this embodiment estimates the engagement of each of the plurality of workers. That is to say, the selector 211 according to this embodiment selects each of the plurality of workers as the first worker. In addition, the selector 211 also selects one or more second workers for a single first worker.

The selector 211 selects the first worker and the second worker(s) by reference to the relationship information, thus reducing the number of times communication needs to be measured compared to a situation where the communication is measured with respect to all possible combinations of pairs of workers (e.g., ₙC₂ combinations if the number of the workers is n). That is to say, making the selector 211 select the first worker and the second worker(s) by reference to the relationship information allows for shortening the time it takes to measure the communication, thus lightening the load on the communication measuring system 1. In addition, the relationship information also includes rank information about the respective positions of the workers. This allows the selector 211 to select a second worker whose position is a particular one for (i.e., who has a predetermined relationship with) the first worker. This allows the communication measuring system 1 according to this embodiment to efficiently measure the quantity of conversation (i.e., the quantity of communication) between the first worker and a second worker whose position is a particular one for the first worker.

The attendance determiner 212 performs attendance determination processing (attendance determination step) including determining whether the first worker and the second worker selected by the selector 211 are present at, or absent from, work. More specifically, the attendance determiner 212 performs the attendance determination processing by determining, on every workday included in a predetermined estimation period, whether the first worker and the second worker are both present at work. Optionally, the attendance determiner 212 may also determine, in every predetermined period defined by dividing a workday more finely into the morning and the afternoon, for example, whether the first worker and the second worker are present at, or absent from, work.

The attendance determiner 212 according to this embodiment performs the attendance determination processing by determining, by reference to at least one piece of information selected from the group consisting of the first piece of location information and the second piece of location information, the attendance/absence information, and the result information of the questionnaire, whether the first worker and the second worker are present at, or absent from, work. For example, as for a workday (or a predetermined period) when the location information of a worker has been acquired, the attendance determiner 212 decides that the worker be present at work. On the other hand, as for a workday when the location information of a worker has not been acquired, the attendance determiner 212 decides that the worker not be present at work (i.e., be absent from work). Determining, by reference to at least one piece of information selected from the group consisting of the first piece of location information and the second piece of location information, the attendance/absence information, and the result information of the questionnaire, whether the first worker and the second worker are present at, or absent from, work allows for determining their attendance or absence more accurately.

The conversation determiner 213 acquires the location information from the location measuring system 3, the voice information from the voice collecting system 4, the relationship information and the map information from the data server 5, the attendance/absence information from the attendance/absence management system 6, and the result information from the questionnaire system 7.

The conversation determiner 213 performs conversation determination processing (conversation determination step) including determining, by reference to multiple pieces of location information and multiple pieces of voice information, whether a plurality of workers are having a conversation or not. More specifically, the conversation determiner 213 performs conversation determination processing (conversation determination step) including determining, by reference to the first and second pieces of location information and the first and second pieces of voice information, whether the first worker and the second worker are having a conversation or not.

When performing the conversation determination processing, the conversation determiner 213 according to this embodiment decides, on the condition that the first piece of voice information indicate the presence of a voice uttered around the first worker and the second piece of voice information indicate the presence of a voice uttered around the second worker, that the first worker and the second worker be having a conversation between them. On the other hand, if at least one of the first piece of voice information or the second piece of voice information indicates the absence of any voice, then the conversation determiner 213 decides that the first worker and the second worker be having no conversation between them. Deciding, in a situation where both the first and second pieces of voice information indicate the presence of any void uttered, that the first worker and the second worker be having a conversation allows for measuring the conversation between workers even more accurately.

In addition, the conversation determiner 213 according to this embodiment performs, as a part of the conversation determination processing, proximity determination processing (proximity determination step) including determining, by reference to the first and second pieces of location information, whether the first worker and the second worker are in close proximity to each other. When deciding, as a result of the conversation determination processing, that the first worker and the second worker be in close proximity to each other, the conversation determiner 213 decides that the first worker and the second worker be having a conversation between them. On the other hand, when deciding that the first worker and the second worker not be in close proximity to each other, the conversation determiner 213 decides that the first worker and the second worker be having no conversation between them. Deciding, under the condition that the first worker and the second worker be in close proximity to each other, that the first worker and the second worker be having a conversation between them contributes to measuring the conversation between the workers even more accurately.

Also, if it turns out, as a result of the proximity determination processing (conversation determination processing), that the distance between the first worker and the second worker is less than a predetermined distance or that the first worker and the second worker are in the same room (the same space), then the conversation determiner 213 according to this embodiment decides that the first worker and the second worker be in close proximity to each other. In other words, if the distance between the first worker's location indicated by the first piece of location information and the second worker's location indicated by the second piece of location information is less than a predetermined distance or if the first worker's location indicated by the first piece of location information and the second worker's location indicated by the second piece of location information both fall within the same room, then the conversation determiner 213 decides that the first worker and the second worker be in close proximity to each other. On the other hand, if the distance between the first worker and the second worker is equal to or greater than a predetermined distance and/or if the first worker and the second worker are in two different rooms (different spaces), then the conversation determiner 213 decides that the first worker and the second worker not be in close proximity to each other. Note that the predetermined distance may be 1 meter, for example. In addition, the conversation determiner 213 determines, by reference to the first and second pieces of location information and the map information, whether the first worker and the second worker are in the same room. Determining, depending on whether the distance between the first worker and the second worker is less than a predetermined distance or whether the first worker and the second worker are in the same room, whether the workers are in close proximity to each other or not allows for more accurately determining whether the workers are in close proximity to each other or not.

Furthermore, if the attendance determiner 212 decides, as a result of the attendance determination processing, that the first worker and the second worker be both present at work, then the conversation determiner 213 according to this embodiment performs the conversation determination processing (conversation determination step) with respect to a workday (or a predetermined period) on which the first worker and the second worker are both determined to be present. If a predetermined estimation period includes multiple workdays on each of which both the first worker and the second worker are present at work, then the conversation determiner 213 performs the conversation determination processing with respect to the multiple workdays.

On the other hand, if a decision has been made, as a result of the attendance determination processing, that at least one of the first worker or the second worker not be present at work (i.e., be absent from work), then the conversation determiner 213 does not perform the conversation determination processing. Making the conversation determiner 213 perform the conversation determination processing only when a decision has been made that both the first worker and the second worker be present at work may limit the target period of the conversation determination processing, thus allowing the load on the conversation determiner 213 to be lightened.

FIG. 2 is a conceptual diagram illustrating the concept of the conversation determination processing to be performed by the conversation determiner 213. The conversation determination processing will now be described with reference to FIG. 2.

In FIG. 2, the “first voice flag” is a voice flag about the first piece of voice information and the “second voice flag” is a voice flag about the second piece of voice information. If a piece of voice information indicates that any voice is uttered around a worker, then the voice flag turns ON. On the other hand, if a piece of voice information indicates that no voice is uttered around a worker, then the voice flag turns OFF. The voice flag may be updated, for example, every minute.

In FIG. 2, the “proximity flag” is a flag indicating the result of the proximity determination processing. If a decision has been made as a result of the proximity determination processing that the first worker and the second worker be in close proximity to each other, then the proximity flag turns ON. On the other hand, if a decision has been made as a result of the proximity determination processing that the first worker and the second worker not be in close proximity to each other, then the proximity flag turns OFF. The proximity flag may be updated, for example, every minute.

In FIG. 2, the “conversation flag” is a flag indicating the result of the conversation determination processing. If a decision has been made as a result of the conversation determination processing that the first worker and the second worker be having a conversation between them, then the conversation flag turns ON. On the other hand, if a decision has been made as a result of the conversation determination processing that the first worker and the second worker be having no conversation between them, then the conversation flag turns OFF. The conversation flag may be updated, for example, every minute If the first piece of voice information indicates that any voice is uttered around the first worker, the second piece of voice information indicates that any voice is uttered around the second worker, and the first worker and the second worker are determined to be in close proximity to each other, then the conversation determiner 213 according to this embodiment decides that the first worker and the second worker be having a conversation between them. In other words, if the first voice flag, the second voice flag, and the proximity flag are all ON, then the conversation determiner 213 decides that the first worker and the second worker be having a conversation between them. On the other hand, if at least one of the first voice flag, the second voice flag, or the proximity flag is OFF, then conversation determiner 213 decides that the first worker and the second worker be having no conversation between them.

In the example illustrated in FIG. 2, the conversation flag turns ON in the period between a time T1 and a time T2, the period between a time T3 and a time T4, the period between a time T5 and a time T6, and the period between a time T7 and a time T8. Note that the period between a time T0 and a time T9, for example, may be one workday or a predetermined period.

The calculator 214 performs, in every predetermined estimation period, calculation processing (calculation step) including calculating, at least one of the number of times, or the duration, of conversations that the first worker and the second worker have had between them during the predetermined estimation period. The calculator 214 performs the calculation processing based on the decision of the conversation determination processing. If the predetermined estimation period includes multiple workdays on which both the first worker and the second worker are present at work, then the calculator 214 calculates at least one of the number of times, or the duration, of conversations that the first worker and the second worker have had between them with respect to the multiple workdays.

The calculator 214 according to this embodiment performs the calculation processing by determining respective points in time when the first worker and the second worker started and ended their conversations and then calculating at least one of the number of times, or the duration, of the conversations that the first worker and the second worker have had between them.

In the example illustrated in FIG. 2, the calculator 214 determines the times T1, T3, T5, and T7 to be points in time when the conversations started and also determines the times T2, T4, T6, and T8 to be points in time when the conversations have ended. That is to say, the calculator 214 according to this embodiment determines the timing when the conversation flag turned ON to be a point in time when the conversation started and determines the timing when the conversation flag turned OFF to be a point in time when the conversation ended.

Thus, the calculator 214 according to this embodiment defines the number of times that the conversation flag has turned ON or OFF to be the number of times of conversations and also defines the sum of the periods during which the conversation flags are ON to be the duration of the conversations. Specifically, in the example shown in FIG. 2, the calculator 214 calculates (measures) the number of times of conversations between the first worker and the second worker on a workday to be four times. In addition, the calculator 214 also calculates the sum of the period between the time T1 and the time T2, the period between the time T3 and the time T4, the period between the time T5 and the time T6, and the period between the time T7 and the time T8 to be the total duration of conversations between the first worker and the second worker on a workday.

The calculation processing according to this embodiment includes determining the respective points in time when the conversations started and ended and then calculating at least one of the number of times, or the duration, of the conversations that the first worker and the second worker have had between them, thus allowing the number of times of conversations or the duration of the conversations to be calculated more accurately.

The estimator 215 performs estimation processing (estimation step) including estimating engagement of each of the plurality of workers in every predetermined estimation period. The estimator 215 according to this embodiment estimates, based on at least one of the number of times, or the duration, of the conversations calculated in the calculation processing, the engagement of the first worker. That is to say, the estimator 215 according to this embodiment uses, as a parameter for use to estimate the engagement of the first worker, at least one of the number of times, or the duration, of conversations, calculated in the calculation processing, between the first worker and the second worker. The engagement of a worker is estimated based on at least one of the number of times, or the duration, of the conversations calculated in the calculation processing, thus allowing for estimating the engagement more accurately.

Furthermore, in the estimation processing according to this embodiment, the engagement per conversation and the engagement per unit time of the duration of the conversations are affected more significantly in a situation where the second worker is a boss of the first worker than in a situation where the second worker is not a boss of the first worker (such as a coworker for the first worker). That is to say, in a situation where the second worker is a boss of the first worker, if there are a large number of times of conversations between the first worker and the second worker or if there is a long duration of conversations between the first worker and the second worker, the engagement of the first worker tends to increase easily. The estimation processing according to this embodiment includes adjusting the degree of influence on the engagement according to the worker's position, thus allowing for estimating the engagement more accurately.

### (3) How Communication Measuring System Works

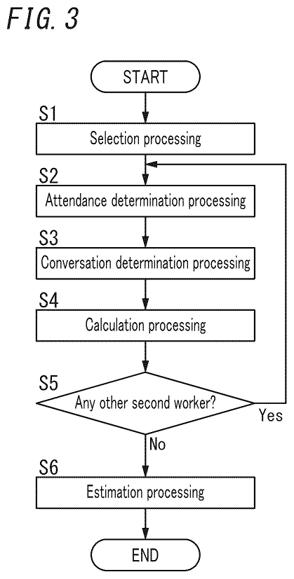

Next, it will be described with reference to FIG. 3 how the communication measuring system 1 works.

First, the communication measuring system 1 performs selecting processing (selection step) (in S1). Specifically, the communication measuring system 1 selects, by reference to relationship information, a single first worker and one or more second workers from a plurality of workers. In this process step, the communication measuring system 1 may select a plurality of second workers for a single first worker. If the selecting processing includes selecting a plurality of second workers, then the communication measuring system 1 according to this embodiment performs the following processing steps S2-S5 on each of the plurality of second workers one by one. That is to say, the communication measuring system 1 according to this embodiment repeatedly performs the same series of processing steps S2-S5 as many times as the number of the second workers selected.

Next, the communication measuring system 1 performs attendance determination processing (attendance determination step) (in S2). Specifically, the communication measuring system 1 determines whether the first worker and the second worker are present at, or absent from, work, thereby selecting a workday (predetermined period) on which the first worker and the second worker are both present at work from a predetermined estimation period.

Subsequently, the communication measuring system 1 performs conversation determination processing (conversation determination step) (in S3). Specifically, the communication measuring system 1 determines, by reference to first and second pieces of location information and first and second pieces of voice information, whether the first worker and the second worker are having a conversation between them.

Thereafter, the communication measuring system 1 performs calculation processing (calculation step) (in S4). Specifically, the communication measuring system 1 calculates, based on a decision made in the conversation determination processing, at least one of the number of times, or the duration, of conversations that the first worker and the second worker have had during the predetermined estimation period.

Next, the communication measuring system 1 determines whether at least one of the number of times, or the duration, of conversations has been calculated with respect to all possible combinations of a single first worker and one or more second workers that have been selected in the selecting processing. In other words, the communication measuring system 1 determines whether there is any other second worker for which the number of times and the duration of conversations with the first worker need to be calculated (in S5).

If there is any other second worker for which the number of times and the duration of conversations need to be calculated (if the answer is YES in Step S5), then the process returns to the processing step S2. On the other hand, if there are no other second workers for which the number of times and the duration of conversations need to be calculated (if the answer is NO in Step S5) (i.e., if at least one of the number of times, or the duration, of conversations between the one or more second workers and the first worker that have been selected in the selecting processing has already been calculated), then the process proceeds to the processing step S6.

In the processing step S6, the communication measuring system 1 performs the estimation processing (estimation step) (in S6). Specifically, the communication measuring system 1 estimates, based on at least one of the number of times, or the duration, of the conversations that has been calculated in the calculation processing, the first worker's engagement. Then, the communication measuring system 1 ends the process.

Note that the flowchart shown in FIG. 3 is only an exemplary procedure and should not be construed as limiting. Optionally, the processing steps shown in FIG. 3 may be performed as appropriate in a different order from the illustrated one, some of the processing steps shown in FIG. 3 may be omitted as appropriate, and/or an additional processing step may be performed as needed.

### (4) Variations

Next, variations of the exemplary embodiment will be enumerated one after another.

### (4.1) First Variation

The calculator 214 may perform the calculation processing by regarding, when an interval between a point in time when a first conversation has ended and a point in time when a second conversation has started is shorter than a predetermined time, the first conversation and the second conversation as a single series of conversations and calculating at least one of the number of times, or the duration, of the conversations that the first worker and the second worker have had. The first conversation is a conversation between the first worker and the second worker. The second conversation is also a conversation between the first worker and the second worker and follows the first conversation. The predetermined time may be 10 minutes, for example. The predetermined time may be changed as appropriate.

For example, the calculator 214 determines whether the interval between a time when the conversation flag has turned from ON to OFF and a time when the conversation flag turns from OFF to ON next time is shorter than the predetermined time or not.

In the example illustrated in FIG. 2, the calculator 214 determines whether the interval between the time T2 and the time T3 is shorter than the predetermined time or not. If the interval between the time T2 and the time T3 is shorter than the predetermined time, then the calculator 214 regards the first conversation that has taken place from the time T1 through the time T2 and the second conversation that has taken place from the time T3 through the time T4 as a single series of conversations. That is to say, if the interval between the time T2 and the time T3 is shorter than the predetermined time, then the calculator 214 decides that a single series of conversations have taken place from the time T1 through the time T4.

In the same way, the calculator 214 determines whether the interval between the time T4 and the time T5 is shorter than the predetermined time or not and also determines whether the interval between the time T6 and the time T7 is shorter than the predetermined time or not.

In the following example, suppose a situation where the calculator 214 has found the interval between the time T2 and the time T3 shorter than the predetermined time, the interval between the time T4 and the time T5 longer than the predetermined time, and the interval between the time T6 and the time T7 shorter than the predetermined time. In that case, the calculator 214 decides that a single series of conversations have taken place from the time T1 through the time T4 and that a single series of conversations have taken place from the time T5 through the time T8. Then, the calculator 214 calculates (measures) the number of times of conversations that the first worker and the second worker have had on a workday to be twice. In addition, the calculator 214 also calculates the sum of the period between the time T1 and the time T4 and the period between the time T5 and the time T8 to be the duration of the conversations that the first worker and the second worker have had on a workday.

The communication measuring system 1 according to the first variation may reduce the chances of causing a decline in the accuracy of the number of times and duration of conversations calculated due to either partial loss, or the limit of accuracy, of the location information and voice information.

### (4.2) Other Variations

The communication measuring system 1 according to the present disclosure or the agent that performs the communication measuring method according to the present disclosure includes a computer system. The computer system may include a processor and a memory as principal hardware components thereof. The computer system performs the functions of the communication measuring system 1 according to the present disclosure or serves as the agent that performs the communication measuring method according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

In the embodiment described above, the plurality of functions of the communication measuring system 1 are integrated together in a single housing. However, this is not an essential configuration for the communication measuring system 1. Alternatively, those constituent elements of the communication measuring system 1 may be distributed in multiple different housings. Still alternatively, at least some functions of the communication measuring system 1 (e.g., some functions of the communication measuring device 2) may be implemented as a cloud computing system as well.

Conversely, at least some functions of the communication measuring system 1, which are distributed in multiple devices in the exemplary embodiment described above, may be aggregated together in a single housing. For example, some functions of the communication measuring system 1, which are distributed in the data server 5 and the attendance/absence management system 6, may be aggregated together in a single housing.

The communication measuring system 1 only needs to include at least the selector 211, the conversation determiner 213, and the calculator 214. That is to say, the communication measuring system 1 only needs to calculate at least one of the number of times, or the duration, of conversations that the workers have had between them. Thus, the communication measuring system 1 does not have to be used to estimate the engagement of a worker.

Optionally, one of the mobile device 31 or the mobile device 41 may also serve as the other of the mobile device 31 or the mobile device 41. That is to say, the mobile device 31 may acquire voice information representing the state of any voice around a worker and transmit the voice information thus acquired to the voice collecting device 40. Also, the mobile device 41 may receive a beacon signal, measure the received signal strength indicator of the beacon signal, and transmit information about the received signal strength indicator to the location measuring device 30.

In the foregoing description of embodiments, a situation where the image capturing unit 32 identifies a worker shot within the image capturing range has been described as an example. However, the image capturing unit 32 does not have to identify the worker shot within the image capturing range. Alternatively, the location measuring device 30 that has received, from the image capturing unit 32, a captured image and information representing the identifier of the image capturing unit 32 may identify the worker shot within the image capturing range of the captured image.

### Recapitulation

As can be seen from the foregoing description, a communication measuring method according to a first aspect is performed by a computer system. The communication measuring method includes a selection step, a conversation determination step, and a calculation step. The selection step includes selecting a first worker and a second worker by reference to relationship information about a relationship between one worker and another worker. The conversation determination step includes determining, by reference to a first piece of location information, a second piece of location information, a first piece of voice information, and a second piece of voice information, whether or not the first worker and the second worker are having a conversation. The first piece of location information is a piece of information indicating the location of the first worker. The second piece of location information is a piece of information indicating the location of the second worker. The first piece of voice information is a piece of information indicating a state of a voice around the first worker. The second piece of voice information is a piece of information indicating a state of a voice around the second worker. The calculation step includes calculating, based on a decision made in the conversation determination step, at least one of a numerical number of times, or a duration, of conversations that the first worker and the second worker have had.

This aspect contributes to measuring a conversation between workers more accurately than, for example, a system for determining, by reference to location information and time, whether workers are having a conversation between them.

In a communication measuring method according to a second aspect, which may be implemented in conjunction with the first aspect, the first piece of location information and the second piece of location information are either pieces of location information of mobile devices (31) carried by the first worker and the second worker, respectively, or pieces of location information acquired by having the first worker and the second worker shot by an image capturing unit (32) installed in a workplace.

This aspect contributes to measuring a conversation between workers even more accurately by using either the pieces of location information of mobile devices (31) carried by the workers, or pieces of location information acquired by having the workers shot by an image capturing unit (32) installed in a workplace.

In a communication measuring method according to a third aspect, which may be implemented in conjunction with the first or second aspect, the first piece of voice information and the second piece of voice information are either pieces of voice information acquired by mobile devices (31) carried by the first worker and the second worker, respectively, or pieces of voice information picked up by a microphone (42) installed in a workplace.

This aspect contributes to measuring a conversation between workers even more accurately by using either pieces of voice information acquired by mobile devices (41) carried by the workers or pieces of voice information picked up by a microphone (42) installed in a workplace.

In a communication measuring method according to a fourth aspect, which may be implemented in conjunction with any one of the first to third aspects, the conversation determination step includes deciding, under a condition that the first piece of voice information indicate the presence of any voice uttered around the first worker and the second piece of voice information also indicate the presence of any voice uttered around the second worker, that the first worker and the second worker be having a conversation.

According to this aspect, a decision is made, in a situation where the first piece of voice information and the second piece of voice information both indicate the presence of any voice uttered, that the first worker and the second worker be having a conversation between them, thus contributing to measuring the conversation between the workers even more accurately.

In a communication measuring method according to a fifth aspect, which may be implemented in conjunction with any one of the first to fourth aspects, the conversation determination step includes determining, by reference to the first piece of location information and the second piece of location information, whether the first worker and the second worker are in close proximity to each other, and deciding, under a condition that the first worker and the second worker are determined to be in close proximity to each other, that the first worker and the second worker be having a conversation.

According to this aspect, a decision is made, under the condition that the first worker and the second worker be in close proximity to each other, that the first worker and the second worker be having a conversation between them, thus contributing to measuring the conversation between the workers even more accurately.

In a communication measuring method according to a sixth aspect, which may be implemented in conjunction with any one of the first to third aspects, the conversation determination step includes: determining, by reference to the first piece of location information and the second piece of information, whether the first worker and the second worker are in close proximity to each other; and deciding, under a condition that the first piece of voice information indicate the presence of any voice uttered around the first worker, the second piece of voice information also indicate the presence of any voice uttered around the second worker, and that the first worker and the second worker be determined to be in close proximity to each other, that the first worker and the second worker be having a conversation.

According to this aspect, a decision is made, under the condition that the first worker and the second worker be in close proximity to each other and the first piece of voice information and the second piece of voice information both indicate the presence of any voice uttered, that the first worker and the second worker be having a conversation, thus contributing to measuring the conversation between the workers even more accurately.

In a communication measuring method according to a seventh aspect, which may be implemented in conjunction with the fifth or sixth aspect, the conversation determination step includes deciding, when a distance between the first worker and the second worker is less than a predetermined distance or when the first worker and the second worker are in the same room, that the first worker and the second worker be in close proximity to each other.

This aspect allows for more accurately determining whether the workers are in close proximity to each other.

A communication measuring method according to an eighth aspect, which may be implemented in conjunction with any one of the first to seventh aspects, further includes an attendance determination step. The attendance determination step includes determining whether the first worker and the second worker are present at, or absent from, work. The communication measuring method includes performing the conversation determination step when a decision is made in the attendance determination step that the first worker and the second worker be both present at work.

According to this aspect, the conversation determination step is performed when a decision is made that the first worker and the second worker be both present at work, thus allowing for lightening the load on the conversation determination step.

In a communication measuring method according to a ninth aspect, which may be implemented in conjunction with the eighth aspect, the attendance determination step includes determining, by reference to at least one piece of information selected from the group consisting of the first piece of location information and the second piece of location information, attendance/absence information indicating whether the first worker and the second worker are present at, or absent from, work, and information about results of a questionnaire distributed to workers, whether the first worker and the second worker are present at, or absent from, work.

This aspect allows for more accurately determining whether the workers are present at, or absent from, work.

In a communication measuring method according to a tenth aspect, which may be implemented in conjunction with any one of the first to ninth aspects, the calculation step includes determining respective points in time when the first worker and the second worker started and ended their conversations and then calculating at least one of the numerical number of times, or the duration, of the conversations that the first worker and the second worker have had.

According to this aspect, respective points in time when the workers started and ended their conversations are determined and then at least one of the number of times, or the duration, of the conversations between the first worker and the second worker is calculated, thus allowing for more accurately calculating the number of times, or the duration, of their conversations.

In a communication measuring method according to an eleventh aspect, which may be implemented in conjunction with the tenth aspect, the calculation step includes regarding, when an interval between a point in time when a first conversation has ended and a point in time when a second conversation has started is shorter than a predetermined time, the first conversation and the second conversation as a single series of conversations and calculating at least one of the numerical number of times, or the duration, of the conversations. The first conversation is a conversation between the first worker and the second worker. The second conversation is also a conversation between the first worker and the second worker and follows the first conversation.

This aspect may reduce the chances of causing a decline in the accuracy of the number of times and duration of conversations calculated due to either partial loss, or the limit of accuracy, of the location information and voice information.

In a communication measuring method according to a twelfth aspect, which may be implemented in conjunction with any one of the first to eleventh aspects, the relationship information includes a piece of information about respective positions at work of the one worker and the other worker to indicate which worker is higher in rank than the other worker.

According to this aspect, the relationship information includes a piece of information about respective positions at work of the workers, thus allowing, for example, a worker who is a boss of the first worker and would have significant influence on the first worker's engagement, to be selected as the second worker.

A communication measuring method according to a thirteenth aspect, which may be implemented in conjunction with any one of the first to twelfth aspects, further includes an estimation step. The estimation step includes estimating engagement of the first worker based on at least one of the numerical number of times, or the duration, of the conversations calculated in the calculation step.

According to this aspect, the engagement of the worker is estimated based on at least one of the number of times or the duration of the conversation calculated in the calculation step, thus allowing for estimating the engagement more accurately.

In a communication measuring method according to a fourteenth aspect, which may be implemented in conjunction with the thirteenth aspect, the engagement per conversation and the engagement per unit time of the conversation estimated in the estimation step are affected more significantly in a situation where the second worker is a boss of the first worker than in a situation where the second worker is not a boss of the first worker.

According to this aspect, the degree of influence on engagement is adjusted according to the worker's position, thus allowing for estimating the engagement more accurately.

Note that the features according to the second to fourteenth aspects are not essential features for the communication measuring method but may be omitted as appropriate.

A program according to a fifteenth aspect is designed to cause one or more processors to perform the communication measuring method according to any one of the first to fourteenth aspects.

This aspect contributes to measuring a conversation between workers more accurately than, for example, a system for determining, by reference to location information and time, whether workers are having a conversation between them.

A communication measuring system (1) according to a sixteenth aspect includes a selector (211), a conversation determiner (213), and a calculator (214). The selector (211) selects a first worker and a second worker by reference to relationship information about a relationship between one worker and another worker. The conversation determiner (213) determines, by reference to a first piece of location information, a second piece of location information, a first piece of voice information, and a second piece of voice information, whether or not the first worker and the second worker are having a conversation. The first piece of location information is a piece of information indicating the location of the first worker. The second piece of location information is a piece of information indicating the location of the second worker. The first piece of voice information is a piece of information indicating a state of a voice around the first worker. The second piece of voice information is a piece of information indicating a state of a voice around the second worker. The calculator (214) calculates, based on a decision made by the conversation determiner (213), at least one of a numerical number of times, or a duration, of conversations that the first worker and the second worker have had.

This aspect contributes to measuring a conversation between workers more accurately than, for example, a system for determining, by reference to location information and time, whether workers are having a conversation between them.

### REFERENCE SIGNS LIST

1 Communication Measuring System
211 Selector
213 Conversation Determiner
214 Calculator
31 Mobile Device
32 Image Capturing Unit
41 Mobile Device
42 Microphone

1. A communication measuring method to be performed by a computer system, the communication measuring method including:
selecting a first worker and a second worker by reference to relationship information acquired from a data server about a relationship between one worker and another worker;
determining whether the first worker and the second worker are present at, or absent from, work, based on attendance/absence information acquired from an attendance/absence management system;
determining, when a decision is made that the first worker and the second worker be both present at work, by reference to a first piece of location information indicating a location of the first worker and, a second piece of location information indicating a location of the second worker, acquired from a location measuring device, and a first piece of voice information indicating a state of a voice around the first worker, and a second piece of voice information indicating a state of a voice around the second worker, acquired from a voice collecting device, whether or not the first worker and the second worker are having a conversation;
calculating, at least one of a numerical number of times, or a duration, of conversations that the first worker and the second worker have had when a decision is made that the first worker and the second worker are having the conversation.

2. The communication measuring method of claim 1, wherein
the first piece of location information and the second piece of location information are either pieces of location information of mobile devices carried by the first worker and the second worker, respectively, or pieces of location information acquired by having the first worker and the second worker shot by an image capturing unit installed in a workplace.

3. The communication measuring method of claim 1, wherein
the first piece of voice information and the second piece of voice information are either pieces of voice information acquired by mobile devices carried by the first worker and the second worker, respectively, or pieces of voice information picked up by a microphone installed in a workplace.

4. The communication measuring method of claim 1, wherein,
the determining whether or not the first worker and the second worker are having the conversation includes deciding, under a condition that the first piece of voice information indicate the presence of any voice uttered around the first worker and the second piece of voice information also indicate the presence of any voice uttered around the second worker, that the first worker and the second worker be having a conversation.

5. The communication measuring method of claim 1, wherein
the determining whether or not the first worker and the second worker are having the conversation includes determining, by reference to the first piece of location information and the second piece of location information, whether the first worker and the second worker are in close proximity to each other, and deciding, under a condition that the first worker and the second worker be determined to be in close proximity to each other, that the first worker and the second worker be having a conversation.

6. The communication measuring method of claim 1, wherein
the determining whether or not the first worker and the second worker are having the conversation includes
determining, by reference to the first piece of location information and the second piece of information, whether the first worker and the second worker are in close proximity to each other; and
the determining whether or not the first worker and the second worker are having the conversation includes deciding, under a condition that the first piece of voice information indicate the presence of any voice uttered around the first worker, the second piece of voice information also indicate the presence of any voice uttered around the second worker, and that the first worker and the second worker be determined to be in close proximity to each other, that the first worker and the second worker be having a conversation.

7. The communication measuring method of claim 5, wherein
the determining whether or not the first worker and the second worker are having the conversation includes deciding, when a distance between the first worker and the second worker is less than a predetermined distance or when the first worker and the second worker are in the same room, that the first worker and the second worker be in close proximity to each other.

8. (canceled)

9. The communication measuring method of claim 1, wherein
the determining whether the first worker and the second worker are present at, or absent from, work includes determining, by reference to at least one piece of information selected from the group consisting of the first piece of location information and the second piece of location information, attendance/absence information indicating whether the first worker and the second worker are present at, or absent from, work, and information about results of a questionnaire distributed to workers, whether the first worker and the second worker are present at, or absent from, work.

10. The communication measuring method of claim 1, wherein
the calculating includes determining respective points in time when the first worker and the second worker started and ended their conversations and then calculating at least one of the numerical number of times, or the duration, of the conversations that the first worker and the second worker have had.

11. The communication measuring method of claim 10, wherein
the calculating includes regarding, when an interval between a point in time when a first conversation between the first worker and the second worker has ended and a point in time when a second conversation between the first worker and the second worker has started following the first conversation is shorter than a predetermined time, the first conversation and the second conversation as a single series of conversations and calculating at least one of the numerical number of times, or the duration, of the conversations.

12. The communication measuring method of claim 1, wherein
the relationship information includes a piece of information about respective positions at work of the one worker and the other worker to indicate which worker is higher in rank than the other worker.

13. The communication measuring method of claim 1, further comprising estimating engagement of the first worker based on at least one of the numerical number of times, or the duration, of the conversations calculated.

14. The communication measuring method of claim 13, wherein
the engagement per conversation and the engagement per unit time of the conversation estimated are affected more significantly in a situation where the second worker is a boss of the first worker than in a situation where the second worker is not a boss of the first worker.

15. A non-transitory storage medium storing thereon a program designed to cause one or more processors to perform the communication measuring method of claim 1.

16. A communication measuring system comprising:
a selector configured to select a first worker and a second worker by reference to relationship information about a relationship between one worker and another worker;
a conversation determiner configured to determine, by reference to a first piece of location information indicating a location of the first worker, a second piece of location information indicating a location of the second worker, a first piece of voice information indicating a state of a voice around the first worker, and a second piece of voice information indicating a state of a voice around the second worker, whether or not the first worker and the second worker are having a conversation;
a calculator configured to calculate, based on a decision made by the conversation determiner, at least one of a numerical number of times, or a duration, of conversations that the first worker and the second worker have had; and
an attendance determiner being configured to determine whether the first worker and the second worker are present at, or absent from, work,
the conversation determiner being configured to determine whether or not the first worker and the second worker are having a conversation, when the attendance determiner decides that the first worker and the second worker be both present at work.
